(19) United States
(12) Patent Application Publication
(10) Pub. No.: US 2002/0038728 A1
(43) Pub. Date: Apr. 4, 2002

(54) Method and apparatus for making a load cell

(75) Inventor: Michael Allan Dingman, Utica, MI (US)

Correspondence Address: LAURA M. SLENZAK, SIEMENS CORPORATION, 186 WOOD AVENUE SOUTH, ISELIN, NJ, 08830, US

(73) Assignee: Siemens Automotive Corporation

(21) Appl. No.: 09/888,901

(22) Filed: Jun. 25, 2001

Related U.S. Application Data
(60) Provisional application No. 60/237,209, filed on Oct. 2, 2000.

(51) Int. Cl. G01G 9/00; G01G 17/00

(52) U.S. Cl. 177/1; 73/1.15; 73/1.13

(57) ABSTRACT

A unique method and apparatus for making a load cell provides faster assembly throughput and a manufacturing cost reduction. The method and apparatus includes adhering a sensor to a metal surface and clamping the sensor to the metal surface with heated clamps. Heat is applied directly through the clamps to heat the interface between the sensor and metal surface for a predetermined amount of time to form a secure bond.

### RELATED APPLICATIONS

This application claims priority to provisional application 60/237,209 filed on Oct. 2, 2000.

### BACKGROUND OF THE INVENTION

1. Field of the Invention

This invention relates to a method and apparatus for making a load cell. Specifically, sensors are secured to mounts by using a heated clamping mechanism.

2. Related Art

Load cells are used to measure weight forces exerted against the cells. Load cells can be used in various applications and are often used to determine seat occupant weight. The load cells are mounted to a seat structure, such as a seat bottom, and are used to measure the weight force exerted against the seat bottom by the seat occupant.

Current load cells are made by adhering a sensor, such as a strain gage, to a mounting member. The sensor and mounting member are clamped together under pressure and are then placed into an oven for several hours to heat the mounting member, clamps, and adhesive together to form a proper bond. This process is time consuming because a significant amount of time is required to (a) bring the oven up to the proper temperature; (b) heat the component for the desired amount of time; and (c) cool the component. The process is also expensive because the oven required to perform the heating step is costly in addition to taking up a significant amount of workspace. Another disadvantage with this clamps are required to apply the proper amount of pressure. Additionally, the clamps must be carefully calibrated and monitored while in the oven to ensure that the proper pressure is being applied, which is time consuming.

Thus, it is desirable to have a method and apparatus for making a load cell that eliminates the need for an oven and which significantly reduces manufacturing time and cost in addition to overcoming the above referenced deficiencies with prior art systems.

### SUMMARY OF THE INVENTION

The subject invention includes a method and apparatus for making a load cell. A sensor is attached to a mount, a pressure force is applied to the sensor against the mount with a pressure member, and the sensor and mount are heated through the pressure member to form a secure bond between the sensor and the mount.

The sensor is preferably a strain gage that is mounted to a metal member defining a mounting surface. In the preferred embodiment, the strain gage is adhered to the mounting surface with an adhesive. At least one clamp is used to provide the pressure force. The clamp is a heated clamp having an internal heat producing mechanism such that heat can be applied directly through the clamp to the strain gage and the metal member. The heat is applied for a predetermined length of time to provide a secure bond between the strain gage and the metal member. Once a proper bond has been formed, the clamp is removed.

The subject invention provides a method and apparatus for manufacturing a load cell that provides faster assembly throughput and reduces manufacturing costs. Some additional advantages include eliminating the need for a heating oven, reducing heating times, faster cool down of complete components, a reduction in energy consumption. These and other features of the present invention can be best understood from the following specification and drawings, the following of which is a brief description.

### BRIEF DESCRIPTION OF THE DRAWINGS

FIG. 1 is a schematic representation of load cell made according to the subject invention.

FIG. 2 is a schematic view a load cell manufactured according to the subject invention.

### DETAILED DESCRIPTION OF AN EXEMPLARY EMBODIMENT

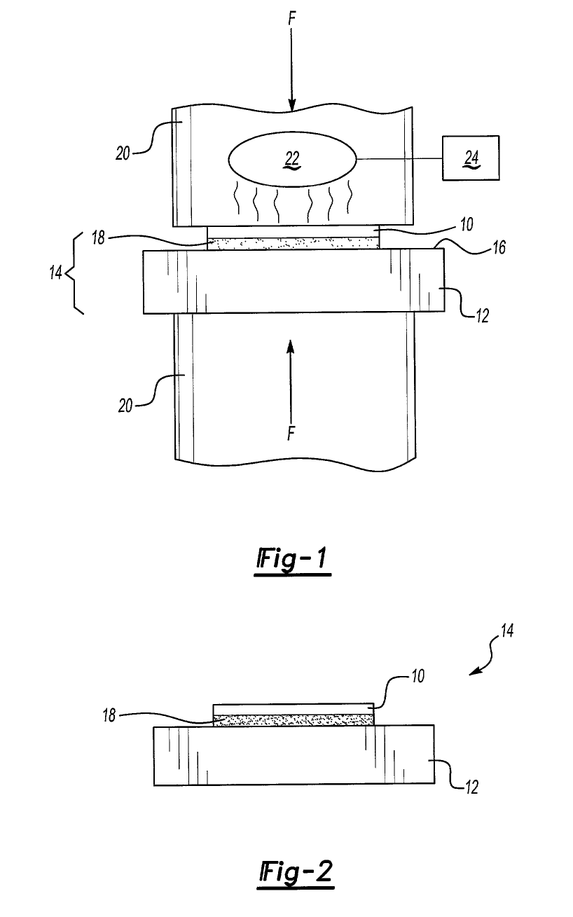

As seen in FIG. 1, at least one sensor 10 is mounted to a mounting member 12 to form a load cell, shown generally at 14. Any type of known sensor can be used but preferably the sensor 10 is a strain gage. Also, multiple sensors 10 could be mounted to a single mounting member 12 depending upon the application. The mounting member 12 is a metallic member defining a mounting surface 16.

The strain gage 10 is mounted to the metallic member 12 with an adhesive 18. A pressure force F is applied to the strain gage 10 against the metallic member 12 with a pressure applying member 20 after the adhesive 18 has been applied. The pressure applying member 20 is a heated clamp having an internal heating mechanism 22 connected to a power source 24. Any type of heating mechanism known in the art could be used. The power source 24 can be an internal battery, an external electrical connection, or any other similar device known in the art.

At least one heated clamp 20 is required and multiple clamps 20 can be used depending on the size of the clamps 20 and the number of strain gages 10 being adhered to the metallic member 12.

The clamps 20 clamp the strain gage 10 and the metallic member 12 together under a predetermined pressure force F. The internal heating mechanism 22 of the clamp 20 applies heat directly through the clamp 20 to the strain gage 10 and the metallic member 12. This allows for faster heating of the component and eliminates the need for an oven. The heat is applied for a predetermined amount of time such that a proper and secure bond is formed between the strain gage 10 and the metallic member 12. Once a proper bond has been formed, the clamps 20 are removed forming a finished load cell 14, shown in FIG. 2.

The subject method and apparatus has the advantage of being able to provide a dual use of the clamping requirement by using a heated clamp 20 to apply the pressure force F as well as applying heat directly through the clamp 20 to heat the interface area between the strain gage 10 and the metallic member 12. In addition to eliminating the oven, less time is needed for heating the components and less clamping time is required. Other benefits include a reduction in the overall number of clamps required for assembly, less calibration of clamps for proper pressure force application, less workspace is occupied by the manufacturing equipment, less energy is used, and the components are cooled down faster.

Although a preferred embodiment of this invention has been disclosed, it should be understood that a worker of ordinary skill in the art would recognize many modifications come within the scope of this invention. For that reason, the following claims should be studied to determine the true scope and content of this invention.

I claim:

1. A method for making a load cell comprising the steps of:
(a) attaching a sensor to a mount;
(b) applying a pressure force to the sensor against the mount with a pressure member;
(c) heating the sensor and mount through the pressure member to form a secure bond between the sensor and the mount.

2. The method according to claim 1 wherein the pressure member is at least one clamp and step (b) includes clamping the sensor and the mount together.

3. The method according to claim 2 wherein the clamp is a heating clamp having an internal heating source and step (c) includes heating the sensor with the heating clamp for a predetermined amount of time to form the bond.

4. The method according to claim 3 including removing the clamp after the heating process has been completed.

5. The method according to claim 3 wherein step (a) includes adhering the sensor to the mount with an adhesive.

6. The method according to claim 5 wherein the sensor is a strain gage and the mount defines a metal surface and step (a) includes adhering the strain gage to the metal surface.

7. A method for making a load cell comprising the steps of
(a) adhering a strain gage to a metal member;
(b) clamping the strain gage and the metal member together with at least one clamp; and
(c) heating the strain gage and metal member through the clamp to form a secure bond between the strain gage and the metal member.

8. The method according to claim 7 including removing the clamp after heating the strain gage and the metal member for a predetermined amount of time.

9. The method according to claim 7 wherein the clamp includes an internal heating source and step (c) includes applying heat to the strain gage and the metal member directly from the heating source inside the clamp.

10. A system for making a load cell comprising:
a sensor attached to a mount; and
at least one heated clamp for clamping said sensor and said mount together and including an internal heating mechanism for applying heat to said sensor and said mount for a predetermined amount of time to form a secure bond between said sensor and said mount.

11. The system according to claim 10 wherein said sensor is adhered to said mount with an adhesive.

12. The system according to claim 10 wherein said sensor is a strain gage and said mount is a metal member defining a mounting surface for receiving said strain gage.

13. The system according to claim 10 including a power source for supplying energy to said internal heating mechanism.
